(19) United States
(12) Patent Application Publication
(10) Pub. No.: US 2026/0125260 A1
(43) Pub. Date: May 7, 2026

(54) SYSTEM AND METHOD FOR AUTOMATIC TANK GAUGE SUPERVISION

(71) Applicant: Gilbarco Inc., Greensboro, NC (US)

(72) Inventors: Martin Cohen, New Britain, CT (US); Mark Dietrech, Southington, CT (US); Bill Umbach, Simsbury, CT (US); Adam Reynolds, West Hartford, CT (US)

(21) Appl. No.: 19/376,538

(22) Filed: Oct. 31, 2025

Related U.S. Application Data
(60) Provisional application No. 63/715,348, filed on Nov. 1, 2024.

(51) Int. Cl. B67D 7/08; B67D 7/32; H04L 9/40

(52) U.S. Cl. CPC B67D 7/085; B67D 7/3281; H04L 63/0442

(57) ABSTRACT

An automatic tank gauge supervisory system for use with a plurality of automatic tank gauge devices located at multiple geographically dispersed fueling sites. The system comprises a remote computing resource in operative communication with the plurality of automatic tank gauge devices. The remote computing resource is operative to receive status information from a respective one of the automatic tank gauge devices and based on the information, command an action to be taken or transmit a notification.

### CROSS-REFERENCE TO A RELATED APPLICATION

This application is based upon and claims the benefit of provisional application Ser. No. 63/715,348, filed Nov. 1, 2024, incorporated fully herein by reference for all purposes.

### FIELD

The present invention relates generally to automatic tank gauges (ATG) such as those used in fuel dispensing environments. More particularly, the present invention relates to a system for remote monitoring and maintenance of an ATG.

### BACKGROUND

Automatic tank gauges are widely used in fuel storage, distribution, and various other industries for monitoring, measurement, and data reporting of liquid levels within storage tanks. ATGs, such as those manufactured by Veeder-Root Company, have become essential components in managing tank inventory, ensuring regulatory compliance, detecting leaks, and optimizing fuel logistics. These systems are critical in industries dependent on the safe and efficient storage of liquid assets, including petroleum refueling stations, chemical processing facilities, and manufacturing plants.

Traditional ATG systems, including models such as Veeder-Root's TLS-450PLUS, leverage a combination of probe-based sensors and control consoles to monitor product levels, temperature, water presence, and tank conditions in real time. Standard ATG units typically use in-tank probes to measure liquid levels and identify water intrusion, then relay this information to a control console for local monitoring. These data points enable operators to maintain accurate inventory control, prevent costly overfills, and respond promptly to leak indications, all of which are fundamental to operational safety and environmental protection.

In recent years, there has been a significant industry shift toward remote monitoring and maintenance capabilities in ATGs, driven by advancements in communication technology and the increasing need for centralized, real-time oversight. Many ATG systems offer network connectivity options that support remote access via Ethernet, cellular, or other wireless communication methods. This remote functionality enables operators to monitor tank conditions from a centralized location, allowing for proactive inventory management, compliance tracking, and immediate notification of critical events, such as leak detection or temperature fluctuations, regardless of the operator's physical location.

Remote monitoring capabilities have also facilitated the development of remote servicing that allows service teams to perform system diagnostics, troubleshoot issues, and, in some cases, implement software updates without requiring on-site visits. Such remote maintenance abilities are rudimentary at best. Although there have been various attempts to solve this problem using the available communication ports of the ATG, these provide only a very limited set of options for performing remote maintenance as that interface is primarily aimed at facilitating data interfaces between devices at the facility operating an underground storage tank (UST).

ATGs are installed at facilities that need to monitor USTs. Unfortunately, these facilities are often unstaffed or staffed by personnel who are not certified to perform maintenance on an ATG. Oftentimes, a truck and skilled personnel is required to be dispatched to the site to perform maintenance on the ATG. This is a costly operation that often results in downtime for the facility.

### SUMMARY

According to one aspect, the present invention provides an automatic tank gauge supervisory system for use with a plurality of automatic tank gauge devices located at multiple geographically dispersed fueling sites. The system comprises a remote computing resource in operative communication with the plurality of automatic tank gauge devices. The remote computing resource is operative to receive status information from a respective one of the automatic tank gauge devices, and based on the information, command an action to be taken or transmit a notification.

According to an exemplary embodiment, the respective one of the automatic tank gauge devices is in communication with a plurality of sensors devices and the status information includes information from at least one of the sensor devices.

According to an exemplary embodiment, the plurality of sensors devices includes at least two of a level sensor, a temperature sensor, a humidity sensor, a pressure sensor, and a flow rate sensor.

According to an exemplary embodiment, communication between the plurality of automatic tank gauge devices and the remote computing resource is encrypted.

According to an exemplary embodiment, the remote computing resource is capable of authenticating the respective one of the automatic tank gauge devices.

According to an exemplary embodiment, the remote computing resource utilizes a public key infrastructure system for communication with the plurality of automatic tank gauge devices.

According to an exemplary embodiment, commanding an action to be taken or transmitting a notification includes at least one of inventory management, leak detection, environmental compliance actions, and enhancing ATG functionality.

A further aspect of the present invention provides a system comprising a plurality of automatic tank gauge devices located at multiple geographically dispersed fueling sites. A remote computing resource is in operative communication with the plurality of automatic tank gauge devices. The remote computing resource is operative to receive status information from a respective one of the automatic tank gauge devices and, based on the information, command an action to be taken or transmit a notification.

A still further aspect of the present invention provides a method of monitoring a plurality of automatic tank gauge devices located at multiple geographically dispersed fueling sites. The method comprises providing a remote computing resource in operative communication with the plurality of automatic tank gauge devices. Another step involves receiving, at the remote computing resource, status information from a respective one of the automatic tank gauge devices. Another step involves operating the remote computing resource to command an action to be taken or transmit a notification based on the information.

### BRIEF DESCRIPTION OF THE DRAWINGS

A full and enabling disclosure of the present invention, including the best mode thereof directed to one skilled in the art, is set forth in the specification, which makes reference to the appended drawings, in which:

FIG. 1 is a diagrammatic representation of a system for automatic tank gauge supervision in accordance with an embodiment of the present invention.

FIG. 2 shows an exemplary fuel dispensing environment including an ATG to be supervised according to aspects of the present invention;

FIG. 3 is a diagrammatic representation showing components of an ATG according to aspects of the present invention;

FIG. 4 shows a block diagram of an embodiment of the novel system described herein; and

FIG. 5 is a flow chart illustrating certain exemplary methodology in accordance with an aspect of the present invention.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the present disclosure including the appended claims and their equivalents.

In order to provide a new and novel system and method for a more robust and resilient ATG system that enhances both remote monitoring and maintenance capabilities, there is provided a system that incorporates improved sensor technologies capable of self-calibration, predictive diagnostics, and real-time adaptability to environmental changes. This ensures accurate data collection and reporting. In particular, as described further herein, the system allows ATGs to be remotely monitored and for remote maintenance to be performed on them. Advantageously, this innovation leverages common Internet of Things (IoT) best practices so that the solution is secure and trusted.

An advantage of the new and novel system is that expanding interoperability with centralized management systems allows for a more comprehensive, data-driven approach to tank oversight, facilitating proactive maintenance and maximizing system uptime.

Another advantage is that the system builds upon the established capabilities of ATG systems, such as those developed by Veeder-Root, and introduces new functionalities that enhance remote monitoring, predictive maintenance, and overall system reliability.

Still another advantage is that by allowing remote maintenance operations, the time to fix is improved for service organizations and results in lower costs and higher uptime for people who use ATGs in their operations.

A further advantage is the lower cost relative to currently available systems.

An additional advantage is the enhanced security of the system.

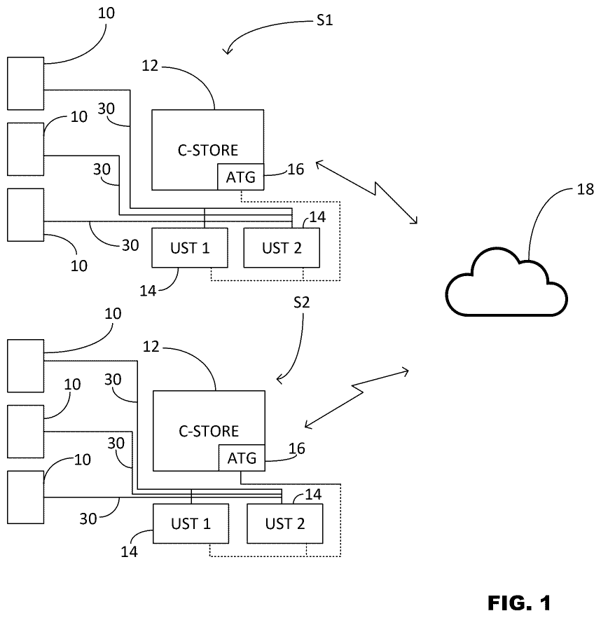

FIG. 1 shows aspects of an ATG supervisory system in accordance with an embodiment of the present invention. In this regard, a plurality of fueling sites S1, S2, etc. (e.g., retail service stations) are illustrated, each having a plurality of fuel dispensers 10. The fuel dispensers are located in the forecourt area of the fueling site, in electrical communication with a point-of-sale (POS) system located in a building such as a respective convenience store (“C-store”) 12. The POS systems authorize payment for the fuel to be dispensed and allow dispensing to begin.

A plurality of USTs 14 are also provided, each containing a respective grade or type of fuel (higher octane, lower octane, diesel, etc.). The USTs 14 supply the selected grade or type of fuel to the dispensers 10 through appropriate piping 30 (e.g., via underground piping). Each of the fuel dispensers 12 and USTs 14 are in electrical communication with an ATG 16, typically located in the C-store 12. The ATGs 16 communicate with a remote supervisory system 18, such as via the cloud.

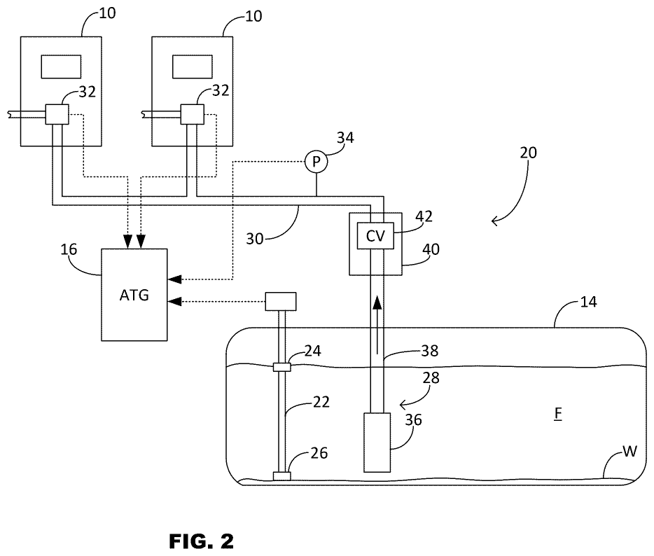

Referring now to FIG. 2, certain additional details regarding the service station S1, S2 may be described. Specifically, FIG. 2 shows a fuel storage and supply system 20 with a fuel storage tank 14, such as a UST, which stores a quantity of fuel F to be dispensed by fuel dispensers 10 in the fueling site. A tank probe 22 extends into the storage tank 14 and has a fuel level sensor 24 for determining the level of fuel F in the storage tank 14 and a water level sensor 26 for determining the level of water W (and any contaminants therein) in the storage tank 14.

A fuel pump, such as pump assembly 28 in the depicted embodiment, is associated with the storage tank 14 to pump the fuel F into a fuel supply line 30 for providing the fuel F to the one or more fuel dispensers 10. The path that the fuel F flows from the fuel pump to the fuel dispensers 10 is the dispenser flow path. The fuel dispensers 10 will have a dispenser flow meter 32 to monitor the dispensing of fuel F by the respective fuel dispensers 10, and the fuel supply line 30 may have one or more line pressure sensor(s) 34.

In embodiment illustrated, the pump assembly 28 includes a pump 36, such as a submersible turbine pump (STP), immersed in the fuel F at the lower end of a column 38. A packer manifold 40, defining a main fluid passageway and a number of ports, is located at the upper end of the column 38. The pump 36 sends the fuel F from the tank 14 through the column 38 to the packer manifold 40 for access at the ports in the packer manifold 40. One of these ports, which is a pump outlet, supplies the fuel supply lines 30. A check valve 42 is typically located along the fluid passageway of the pump assembly 28 between the pump 36 and the pump outlet, to retain fuel F under pressure in the fuel supply lines 30 when dispensing is not occurring and pump 36 is off. As one skilled in the art will appreciate, the packer manifold 40 will typically be located in a containment sump defined below ground level when the storage tank 14 is a UST. One skilled in the art will understand and appreciate that, although illustrated as a submersible turbine pump, the pump 36 may be any configuration that draws fuel F from the storage tank 14. One example of pump 36 is a Red Jacket submersible turbine pump sold by Veeder-Root Company.

ATG 16 manages the storage and supply of fuel F in the fuel storage and supply system 20. (Suitable ATGs include the TLS-450PLUS ATG and the TLS-350 ATG sold by Veeder-Root Company.) The ATG 16 is electrically connected to a tank probe 22 to determine the level of fuel F and water W in the tank 14. The tank probe 22 may also contain other sensors such as one or more temperature sensors and humidity sensors, as necessary or desired. The ATG 16 is also electrically connected to the fuel dispenser meters 32 in the fuel dispensers 10 (or otherwise to control circuitry for the fuel dispensers 10) and to the pump 36. The ATG 34 is also in electrical communication with the pressure sensor(s) 34.

Using information received from the fuel dispenser meters 32, the pressure sensor(s) 34, and/or other sensors, the ATG 16 can operate the pump 36 to satisfy the needs of the fuel dispensers 10. Moreover, the ATG 16 can use the line pressure sensor 34 to detect potential leaks in the fuel supply line 30. Specifically, the ATG 16 can use the pump 36 to pressurize the fuel supply line 30 during a dormant period when the fuel dispensers are not dispensing fuel F. Once the fuel supply line 30 is pressurized, the ATG 16 turns off the pump 36 and monitors the pressure in the supply lines 30 with the line pressure sensor 34. Because of the check valve 42 in the pump assembly 28, the fuel supply line 30 should maintain pressure for a predetermined period. If the ATG 16 determines that the pressure in the fuel supply line 30 decreased too much or too quickly, there is an indication of a leak somewhere in the fuel storage and supply system 20, most likely in the fuel supply line 30. The line pressure sensor 34 used to measure pressure in the fuel supply line 30 may be disposed at any point in the fuel supply line 30 between the pump 36 and a fuel dispenser 10, such as the outlet of the packer manifold 40.

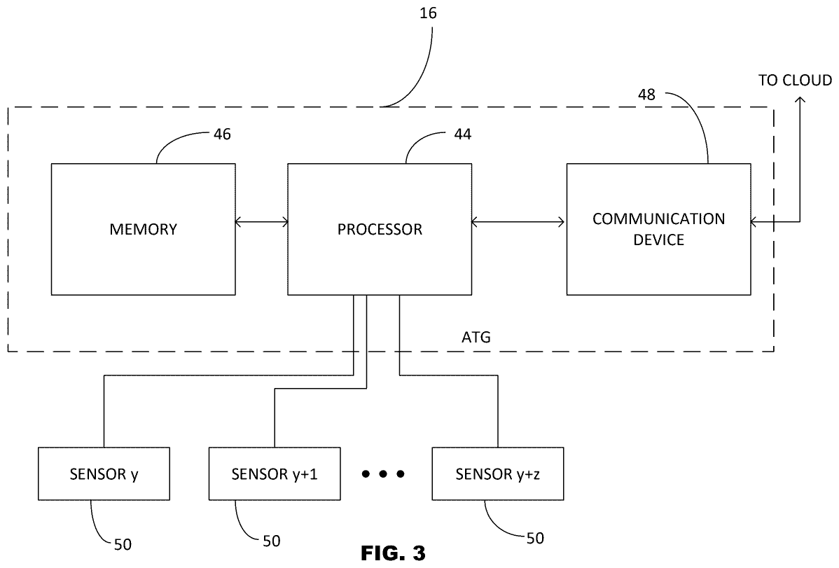

Certain aspects of the ATG 16 may be explained with reference to FIG. 3. As shown, the ATG 16 may include a processor 44, a memory 46, and a communication device 48. Processor 44 may be any suitable electronics whether referred to as a processor, microprocessor, controller, microcontroller, or other suitable electronics with associated memory and software programs running thereon. (As used herein, the foregoing terms, e.g., processor, etc., are all intended to be synonymous.) Memory 46 may be any suitable memory or computer-readable medium as long as it is capable of being accessed by processor 44, including one or more of random access memory (RAM), read-only memory (ROM), erasable programmable ROM (EPROM), or electrically EPROM (EEPROM), CD-ROM, DVD, or other optical disk storage, solid-state drive (SSD), magnetic disc storage, including floppy or hard drives, any type of suitable non-volatile memories, such as secure digital (SD), flash memory, memory stick, or any other medium that may be used to carry or store computer program code in the form of computer-executable programs, instructions, or data. Processor 44 and memory 46 may be distributed over multiple physical chips as necessary or desired.

Device 48 provides communication with a remote supervisor system 18, which may typically be “in the cloud.” Specifically, communication device 48 may be any suitable device or circuitry embodied in hardware, software, or a combination of hardware and software that is configured to receive and/or transmit data from/to a network and/or any other device or module in communication with the ATG 16, such as via ethernet, DSL, cellular communication, etc. Preferably, the communication device 48 may provide secured, e.g. encrypted, communication between the ATG 16 and remote servers or remote computing devices. Such communication may occur through the site controller or directly from the fuel dispenser via wired or wireless protocols.

As can be seen, processor 44 is preferably in communication with multiple sensors 50, such as various liquid level sensors, pressure sensors, temperature sensors, humidity sensors, line leak detection systems and sensors, etc., as necessary or desired. Such sensors are available from the Veeder-Root company.

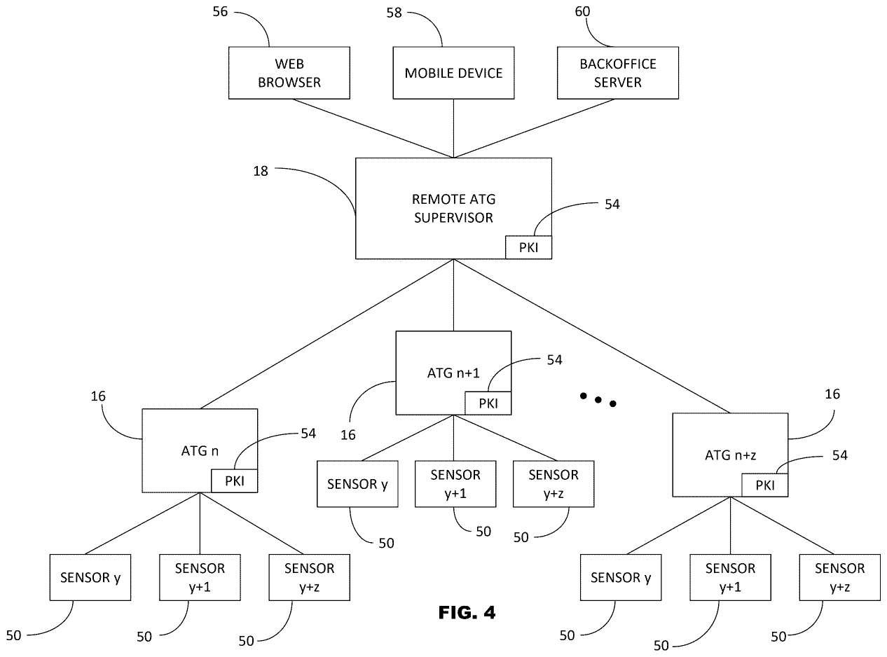

Turning now to FIG. 4, the new and novel ATG supervisor system described herein is illustrated. It includes one or more ATGs 16 and a remote computing resource (server, e.g., Remote ATG Supervisor or cloud) diagrammatically represented by the reference number 18. It will be appreciated that resource 18 will typically comprise one or more processors, memory, communication devices, etc. as necessary or desired. Resource 18 further preferably includes either a Graphical User Interface (GUI) or an Application Program Interface (API). A Public Key infrastructure (PKI) system 54 may also be included as a mechanism to secure communication between the ATG(s) 16 and the resource 18. In addition to encrypting data in transit, system 54 provides authentication of the remote server or cloud by the ATGs 16 and vice versa. Each of the ATGs is in communication with one or more IoT sensor devices for controlling devices or collecting data.

Each of the ATGs 16 is in communication with the remote server/cloud system 18 that captures data from the ATG and requests that the ATG, fueling site, or a third party perform one or more actions. Such actions may include but are not limited to one or more of the following: Inventory management for tracking fuel levels to provide in-tank inventory, supporting business reconciliation, and automatically printing delivery reports; leak detection by performing continuous statistical leak detection (CSLD) to find leaks in tanks and additional leak tests for pressurized lines; alarms and alert detection for identifying alarms, which can indicate leaks, and be configured to send notifications for issues like water in the tank or temperature warnings for products like Diesel Exhaust Fluid (DEF); environmental compliance for helping meet federal, state, and local requirements for release detection by performing and reporting on leak tests; remote monitoring for enabling users to remotely monitor tank data, view reports, and manage alarms from web browsers or mobile apps, ensuring site performance can be tracked from anywhere; and implementation of advanced features where ATG functionality can be expanded with software modules for more advanced functions, such as DEF Recirculation Monitoring Solution to manage the temperature of stored DEF.

A Graphical User Interface (GUI) as well as an Application Program Interface (API) is used for enabling communications between the user and the cloud or remote server. The PKI system generates one or more keys and shares them via a trusted entity, such as the manufacturing facility or a trusted and verified individual. Note that only one of the interfaces is required in this application. Including both interfaces is optional. Furthermore, the system may be deployed on either a remote server or a cloud. Also note that optionally, keys from the PKI system can be installed in a manufacturing environment as needed.

In an alternate or complementary embodiment, the above-described interface sends business data relating to the operation of the UST facility to the remote server or cloud. This business data includes, for example, tank inventory level, fuel delivery information, or fuel dispenser transaction information. Other types of data may also be communicated as needed. The data may be viewed and/or stored in any suitable manner, such as via a web browser 56, mobile device 58, and/or a back-office server 60.

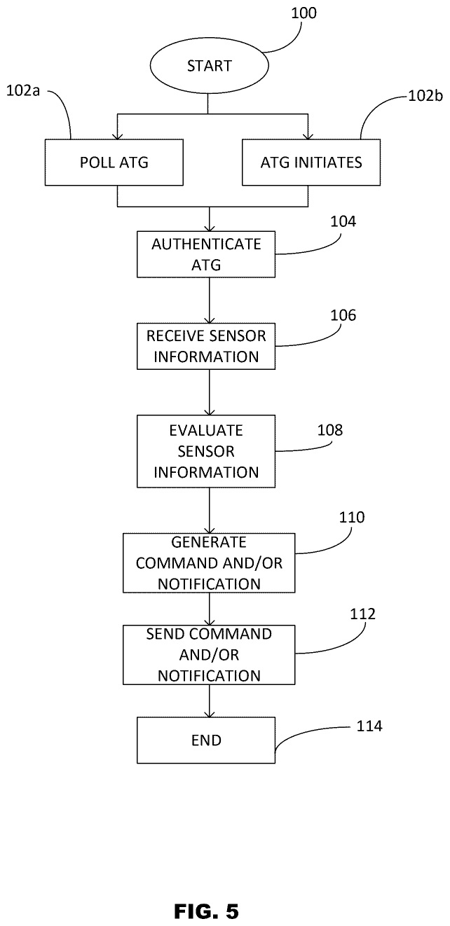

Exemplary methodology in accordance with the present invention is shown in FIG. 5. The process begins at 100. Next, either the resource 18 polls an ATG 16 for status, as shown at 102a, or the ATG initiates communication with the resource 18, as indicated at 102b. For example, the latter may occur periodically or in conjunction with a fueling event. In either case, the ATG 16 is preferably authenticated, as indicated at 104. As indicated at 106, sensor information is received from the ATG 16. The sensor information may be “raw,” or may preferably be subjected to some preprocessing before being sent to resource 18. Further, the sensor information may be in encrypted form and is decrypted when received. In any event, the sensor information is evaluated (as indicated at 108) and one or more commands or notifications are generated (as indicated at 110). The command/notification is sent to the ATG 16 (as indicated at 112) and the process ends (as indicated at 114).

Many modifications and other embodiments of devices and/or methodology set forth herein will come to mind to one skilled in the art to which they pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. An automatic tank gauge supervisory system for use with a plurality of automatic tank gauge devices located at multiple geographically dispersed fueling sites, the system comprising:
a remote computing resource in operative communication with the plurality of automatic tank gauge devices;
the remote computing resource being operative to:
receive status information from a respective one of the automatic tank gauge devices; and
based on the information, command an action to be taken or transmit a notification.

2. An automatic tank gauge supervisory system as set forth in claim 1, wherein the respective one of the automatic tank gauge devices is in communication with a plurality of sensors devices and the status information includes information from at least one of the sensor devices.

3. An automatic tank gauge supervisory system as set forth in claim 2, wherein the plurality of sensors devices includes at least two of a level sensor, a temperature sensor, a humidity sensor, a pressure sensor, and a flow rate sensor.

4. An automatic tank gauge supervisory system as set forth in claim 1, wherein communication between the plurality of automatic tank gauge devices and the remote computing resource is encrypted.

5. An automatic tank gauge supervisory system as set forth in claim 4, wherein the remote computing resource is capable of authenticating the respective one of the automatic tank gauge devices.

6. An automatic tank gauge supervisory system as set forth in claim 5, wherein the remote computing resource utilizes a public key infrastructure system for communication with the plurality of automatic tank gauge devices.

7. An automatic tank gauge supervisory system as set forth in claim 1, wherein commanding an action to be taken or transmitting a notification includes at least one of inventory management, leak detection, environmental compliance actions, and enhancing ATG functionality.

8. A system comprising:
a plurality of automatic tank gauge devices located at multiple geographically dispersed fueling sites; and
a remote computing resource in operative communication with the plurality of automatic tank gauge devices, the remote computing resource being operative to:
receive status information from a respective one of the automatic tank gauge devices; and
based on the information, command an action to be taken or transmit a notification.

9. A system as set forth in claim 8, wherein the respective one of the automatic tank gauge devices is in communication with a plurality of sensors devices and the status information includes information from at least one of the sensor devices.

10. A system as set forth in claim 9, wherein the plurality of sensors devices includes at least two of a level sensor, a temperature sensor, a humidity sensor, a pressure sensor, and a flow rate sensor.

11. A system as set forth in claim 8, wherein communication between the plurality of automatic tank gauge devices and the remote computing resource is encrypted.

12. A system as set forth in claim 11, wherein the remote computing resource is capable of authenticating the respective one of the automatic tank gauge devices.

13. A system as set forth in claim 12, wherein the remote computing resource utilizes a public key infrastructure system for communication with the plurality of automatic tank gauge devices.

14. A system as set forth in claim 8, wherein commanding an action to be taken or transmitting a notification includes at least one of inventory management, leak detection, environmental compliance actions, and enhancing ATG functionality.

15. A method of monitoring a plurality of automatic tank gauge devices located at multiple geographically dispersed fueling sites, the method comprising:
providing a remote computing resource in operative communication with the plurality of automatic tank gauge devices;
receiving, at the remote computing resource, status information from a respective one of the automatic tank gauge devices; and
operating the remote computing resource to command an action to be taken or transmit a notification based on the information.

16. A method as set forth in claim 15, wherein the remote computing resource polls the respective one of the automatic tank gauge devices to prompt the status information.

17. A method as set forth in claim 15, wherein the status information includes sensor information from at least two of a level sensor, a temperature sensor, a humidity sensor, a pressure sensor, and a flow rate sensor.

18. A method as set forth in claim 15, wherein commanding an action to be taken or transmitting a notification includes at least one of inventory management, leak detection, environmental compliance actions, and enhancing ATG functionality.

19. A method as set forth in claim 15, wherein the receiving step involves decrypting the status information.
